(19) United States
(12) Patent Application Publication
(10) Pub. No.: US 2012/0230575 A1
(43) Pub. Date: Sep. 13, 2012

(54) QUANTIFICATION RESULTS IN MULTIPLANE IMAGING

(75) Inventors: Thomas Patrice Jean Arsene Gauthier, Seattle, WA (US); Gerard Joseph Harrison, Snohomish, WA (US)

(73) Assignee: KONINKLIJKE PHILIPS ELECTRONICS N.V., Eindhoven (NL)

(21) Appl. No.: 13/508,421

(22) PCT Filed: Nov. 3, 2010
(86) PCT No.: PCT/IB2010/054979

§ 371 Date: May 7, 2012

Related U.S. Application Data
(60) Provisional application No. 61/258,626, filed on Nov. 6, 2009.

(51) Int. Cl. G06K 9/46

(52) U.S. Cl. 382/131

(57) ABSTRACT

The present invention relates to ultrasound medical imaging for providing information about a region of interest of an object. In particular, the invention relates to an ultrasound medical imaging system and a method for providing information about a region of interest of an object. In order to improve the quantification information provided to the user, a method for providing information about a region of interest of an object is provided, which method comprises the following steps: In a first acquisition step 112, at least a first 114 and a second ultrasound image plane 116 of an object 12 are acquired. Further, a region of interest in the at least first and second image planes of the object is determined 118. Then, first quantification 122 data for the region of interest from the first image plane and second quantification data 124 for the region of interest from the second image plane are determined 120. Next, a composite quantification measurement 128 is generated 126 by combining the determined first quantification data of the first image plane and the determined second quantification data of the second image plane. Further, the composite quantification measurement is provided 130 to the user.

### FIELD OF THE INVENTION

The invention relates to ultrasound medical imaging for providing information about a region of interest of an object. In particular, the invention relates to an ultrasound medical imaging system and a method for providing information about a region of interest of an object.

### BACKGROUND OF THE INVENTION

Ultrasound imaging is used to provide information about a region of interest of an object, for example, to a physician, such as a surgeon. One of many advantages of ultrasound is that it is easy applicable, for example, due to the harmless ultrasound waves applied to a patient. Therefore, ultrasound is used in many medical fields. For enhanced information, for example, contrast enhanced ultrasound is known, wherein ultrasound contrast agents are used consisting of microbubbles, for example. Ultrasound is used for diagnostic and prognostic purposes, for example in the field of oncological, cardiovascular and inflammatory diseases. These are associated with altered regional and/or systemic perfusion, which if measured accurately and reproducibly may be important biomarkers for diagnostic and prognostic purposes. More recently, there has been increasing interest in using contrast enhanced ultrasound to assess altered tissue perfusion, for example. Ultrasound contrast agents such as microbubbles are routinely used in the detection and characterization of focal liver tumours and in a monitoring of local ablative therapies. The advent of novel therapies targeting tumour angiogenesis and vascularity over the last decade has highlighted the need for more accurate and reproducible quantitative techniques to assess more subtle tissue perfusion changes. Imaging modalities such as dynamic contrast enhanced computerized tomography (DCE-CT) and magnetic resonance imaging (DCE-MRI) have been used to assess perfusion changes in monitoring anti-vascular therapies in cancer patients. However, these modalities are limited as the contrast agents used leek freely into the interstitial space and parameters derived from quantification of DCE-CT and DCE-MRI perfusion studies reflect combined flow and permeability. Further, it has been shown that the aspect of reproducibility is not fulfilled. As a further disadvantage, the reliability of quantification results and the certainty that those results are truly representative, for example of the overall tumour perfusion, for example in tumour diagnoses and characterization and also in assessing tumour response to therapy, are not satisfactory for a wide clinical use.

### SUMMARY OF THE INVENTION

Hence, there may be a need to improve the quantification information provided to the user.

According to an exemplary embodiment of the invention, a method for providing information about a region of interest of an object is provided comprising the following steps: In a first step, at least a first and a second ultrasound image plane of an object are acquired. Further, a region of interest in the at least first and second image planes of the object is determined. Then, first quantification data for the region of interest from the first image plane and second quantification data for the region of interest from the second image plane are determined. Next, a composite quantification measurement is generated by combining the determined first quantification data of the first image plane and the determined second quantification data of the second image plane. Further, the composite quantification measurement is provided to the user.

The term “image plane” relates to image data acquired in a geometrical plane during the acquisition of an image. The term “geometrical plane” refers not only to planar planes but also to curved or buckled layers. The term also comprises freely shaped layers, for example. The term “image” relates to the result of an acquisition of image data at one point in time. For example, an image can comprise the acquisition of one image plane. It is also possible to acquire two image planes during one image.

For example, two planes can be acquired such that the regions of interest of the different planes intersect each other in space, such as bi-plane imaging.

Further, an image can also comprise the acquisition of a plurality of image planes and also the acquisition of three-dimensional image data, i.e. a 3D-volume.

For example, 3D image data can be acquired to generate an image plane.

According to an exemplary embodiment of the invention, the first and the second image planes are acquired in one image at one point in time.

According to an exemplary embodiment of the invention, the first and the second image planes are acquired in one image at one point in time in the same geometrical plane.

According to an exemplary embodiment of the invention, the first and the second image planes are acquired in one image at one point in time in different geometrical planes.

According to an exemplary embodiment of the invention, the first and the second image planes are acquired in two images at two points in time in the same geometrical plane.

According to an exemplary embodiment of the invention, the first and the second image planes are acquired in two images at two points in time in different geometrical planes.

According to an exemplary embodiment of the invention, more than two image planes, i.e. a plurality of image planes is acquired, in one or more images and/or in the same or different geometrical planes.

One of the advantages is that the above-mentioned composite quantification measurement contains more information than for example first and second quantification data. This is because composite quantification measurement combines quantification data of at least two image planes. Simply said, in case the acquired image data, i.e. the image plane, is simply shown to the user, this represents so to speak a first level of information. In ultrasound images, it is then possible to analyze the ultrasound image data, for example by measuring certain features shown in an image plane. The process of using ultrasound image data to produce numbers is referred to as “quantification”. Hence, the ultrasound image data is converted into numbers concerning determined aspects, for which the term quantification is used in the description of the present invention. This quantification data can then be provided to the user as a second level of data or second level of information. According to the invention, the quantification data of two image planes is then combined to generate the composite quantification measurement. This composite quantification measurement thus represents information or data on a further or higher level. By providing the composite quantification measurement to the user, the latter is provided with enhanced information he or she can use to improve clinical care, such as in a patient follow-up or diagnostic.

According to an exemplary embodiment of the invention, the region of interest is determined on behalf of the user's input.

This provides the possibility that the user, for example a physician or surgeon, can adjust the region of interest to the particular needs due to the situation at hand.

This so to speak manual determination of the region of interest can also be supported by automated detection depending on set values or parameters. Of course, instead of mixing manual and automated determination of the region of interest, this can also be provided automatically.

According to an exemplary embodiment of the invention, the composite quantification measurement is displayed to the user.

This provides the advantage that the composite quantification measurement can be integrated into visual interfaces which the user is familiar with.

According to an exemplary embodiment of the invention, a method is provided where the first image plane and the second image plane are acquired in different geometrical planes.

For example, the image planes are acquired in bi-plane mode where the regions of interest intersect each other, such as in a perpendicular arrangement.

Although the imaging and quantification of the image planes are performed in 2D only, the acquisition of image planes in different geometrical planes provides spatial information which thus gives the user enhanced information about the three-dimensional situation in the region of interest.

According to an exemplary embodiment of the invention, at least one sequence of image planes is acquired. The first and the second image planes belong to the sequence. Further quantification data for the region of interest is determined for at least a part of the image planes of the sequence.

Thereby it is possible to select image planes for further steps, for example image planes with high contrast thus providing more detailed information.

According to an exemplary embodiment of the invention, quantification data is determined for the region of interest from a plurality of image planes. The composite quantification measurement is generated by combining the determined quantification data of the plurality of image planes.

Using a plurality of image planes, e.g. more than just two image planes, has the advantage that the composite quantification measurement provided to the user represents more information due to the plurality of image planes.

According to an exemplary embodiment of the invention, a first sequence of image planes is acquired from a first geometrical plane and a second sequence of image planes is acquired from a second geometrical plane, for example in a bi-plane mode.

Providing a first and a second sequence of image planes from a first and second geometrical plane respectively allows special information about the region of interest as well as the selection of image planes with image data of maximum quality.

According to an exemplary embodiment of the invention, one of the geometrical planes is the elevation plane and a second plane is the azimuthal plane perpendicular to the elevation plane.

The azimuthal plane is the only scan plane imaged with a non-matrix transducer, whereas the elevational plane is an example for bi-plane images. It is noted that bi-plane imaging is only available on matrix transducers. The two perpendicular planes thus provide more information than just the normal azimuthal plane.

According to an exemplary embodiment of the invention, the image planes of the first and the second sequence are (time) registered. Further, quantification data is determined for the image planes of the first sequence and for the image planes of the second sequence. Still further, the determined quantification data of registered image planes of the first and the second sequences are combined to generate the composite quantification measurement.

According to an exemplary embodiment of the invention, a sequence of composite quantification measurements is generated.

These embodiments provide the advantage that a sequence of composite quantification measurement is provided to the user which gives the user enhanced information about the region of interest in relation to time due to the time registering.

According to an exemplary embodiment of the invention, the step of generating composite quantification measurement comprises averaging the quantification data obtained from one region of interest at different points in time.

The averaging procedure is a sort of basic mathematical combination, for example, suitable for complex quantification data as well as rather simple quantification data. Of course, more complex mathematical functions, formulas or algorithms can be applied for generating the composite quantification measurement. One additional mathematical function can be normalization, which consists for example in dividing quantification data from first region of interest by quantification data from second region of interest.

According to an exemplary embodiment of the invention, the step of combining determined quantification measurement comprises averaging the quantification results of the same region of interest of image planes of different geometrical planes.

By averaging quantification results of image planes of different geometrical planes, the information about the situation in the object is taken into account for a special region of interest in a certain depth of the view. Thus, the acquisition of the image or planes is facilitated, because the method allows for a certain approximate positioning during the acquisition steps. For example, when monitoring tumour response, it is important to image the more or less same geometrical plane in the tumour at different time points during the course of a treatment to ensure that changes in quantification results are due to treatment efficiency rather than to comparing a plane A at one point in time during the treatment with a plane B, which is not equal to plane A, at a later point in time during the treatment. Thus, the method according to the invention allows comparing quantification results obtained over a certain period of time when following the tumour up. By using quantification of several planes, so to speak three-dimensional quantification, individual quantification results, associated with multiple regions of interest, located in a number of scan planes is combined. Further, the composite quantification measurement also provides advantages, for example concerning the overall tumour blood flow. Tumour perfusion is usually heterogeneous and feeding arteries, larger vessels, may be seen in some scan planes but not in others. In other words, information collected in a single plane would then not be representative of the overall tumour blood flow.

According to an exemplary embodiment of the invention, the step of combining determined quantification measurement comprises averaging the composite quantification measurement of one plane and the composite quantification measurement of another plane, each composite quantification measurement referring to the same region of interest.

According to an exemplary embodiment of the invention, the quantification measurements comprise functions over time.

This allows providing information relating to aspects which are depending on dynamic behaviour such as for example aspects relating to blood flow behaviour.

According to an exemplary embodiment of the invention, the function over time is a time-intensity curve.

A time intensity curve provides a more comprehensive representation of tumour blood flow, for example. This is due to, for example, making use of more information about the tumour vascularity. For example, a time intensity curve is computed per region of interest for different planes, such as the azimuthal plane or the elevational plane, as well as “average time intensity curve” which is associated with a virtual region of interest made of the reunion of the region of interest of the azimuthal plane and the region of interest of the elevational plane. Thus, by generating a composite quantification measurement, a so to speak enhanced time intensity curve is provided to the user.

For example, in a more advanced imaging mode, for example available on matrix transducers in which multiple, e.g. more than two, geometrical planes are imaged in real-time and are available for quantification, then averaging of quantification results could be done across a collection of more than two regions of interest, where, for example, one region of interest is drawn on each scan plane.

The advantage of this hypothetic live multiplying imaging mode versus live three-dimensional which is currently available on matrix transducers, is a higher frame rate which increases compared with live 3Ds as a number of scan planes decreases. A high enough frame rate is extremely important in contrast enhanced ultrasound as it is the basis for enabling real-time tissue perfusion imaging and quantification, both of which cannot be achieved with other contrast enhanced imaging modalities, such as DCE-CT or DCE-MR.

According to an exemplary embodiment of the invention, microbubbles are used for enhancing the resolution and the contrast of the image data.

According to an exemplary embodiment of the invention, several sequences are acquired over a period of time, wherein the sequences each comprise at least two image planes. Then, a region of interest is determined in the image planes of the sequences. Further, at least first and second quantification data is determined for the region of interest from the image planes. A composite quantification measurement is generated for each of the sequences by combining determined quantification data of at least a part of the image planes of each sequence. The composite quantification measurements are compared to detect differences and relations. The differences and relations are provided to the user.

Such a comparison and the presentation of the results to the user support the user in evaluating the progress, for example, of medical treatments over a period of time.

According to an exemplary embodiment of the invention, an ultrasound medical imaging system for providing information about a region of interest of an object, wherein the system comprises an ultrasound image data acquisition device comprising an ultrasound probe with an ultrasound transducer, a data processing unit, a display device and an interface unit. The image data acquisition device is adapted to acquire at least a first and a second ultrasound image plane of an object. The interface unit is adapted to determine a region of interest in the at least first and second image planes of the object. The data processing unit is adapted to determine quantification data for the region of interest from the first image plane and to determine quantification data for the region of interest from the second image plane. The data processing unit is further adapted to generate a composite quantification measurement by combining the determined quantification data of the first image plane and the determined quantification data of the second image plane. The display device is adapted to provide the composite quantification measurement to the user.

According to an exemplary embodiment of the invention, the interface unit is adapted such that the region of interest is determined on behalf of the user's input.

According to an exemplary embodiment of the invention, the image data acquisition device is adapted to acquire the first image plane and the second image plane in different geometrical planes.

According to an exemplary embodiment of the invention, the ultrasound transducer is a mechanical transducer or a matrix transducer to acquire live 3D image data.

According to an exemplary embodiment of the invention, the image data acquisition device is adapted to acquire at least one sequence of image planes. The first and the second image planes belong to the sequence. The data processing unit is adapted to determine quantification data for the region of interest for at least a part of the image planes of the sequence.

As an example, planes can be acquired in a single geometrical plane or in different geometrical planes.

According to an exemplary embodiment of the invention, the data processing unit is adapted to determine quantification data for the region of interest from a plurality of image planes and to generate the composite quantification measurement by combining the determined quantification data of the plurality of image planes.

According to an exemplary embodiment of the invention, the image data acquisition device is adapted to acquire a first sequence of image planes from a first geometrical plane and a second sequence of image planes from a second geometrical plane.

According to an exemplary embodiment of the invention, one of the geometrical planes is the elevation plane and a second plane is the azimuthal plane perpendicular to the elevation plane.

According to an exemplary embodiment of the invention, the data processing unit is adapted to (time) register the image planes of the first and the second sequence. The data processing unit is adapted to determine quantification data for the image planes of the first sequence and for the image planes of the second sequence and to combine the determined quantification data of registered image planes of the first and the second sequences to generate the composite quantification measurement.

According to an exemplary embodiment of the invention, the data processing unit is adapted to generate a sequence of composite quantification measurements.

According to an exemplary embodiment of the invention, the data processing unit is adapted to generate composite quantification measurement comprising averaging the quantification results of the same region of interest of image planes of the same geometrical plane.

According to an exemplary embodiment of the invention, the quantification measurements comprise functions over time.

According to an exemplary embodiment of the invention, the function over time is a time-intensity curve.

According to an exemplary embodiment of the invention, the image data acquisition device is adapted to acquire several sequences over a period of time. The data processing unit is adapted to generate a composite quantification measurement for each of the sequences by combining determined quantification data of at least a part of the image planes of each sequence. The data processing unit is further adapted to compare the composite quantification measurements to detect differences and relations. The display device is adapted to provide the differences and relations to the user.

In another exemplary embodiment of the present invention, a computer program or a computer program element is provided that is characterized by being adapted to execute the method steps of the method according to one of the preceding embodiments, on an appropriate system, for example according to one of the embodiments described above.

The computer program element might therefore be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention. Further on, the computer program element might be able to provide all necessary steps to fulfil the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

However, the computer program may also be presented over a network like the World Wide Web and can be down loaded into the working memory of a data processor from such a network. According to a further exemplary embodiment of the present invention, a medium for making a computer program element available for down loading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application.

However, all features can be combined providing synergetic effects that are more than the simple summation of the features.

### BRIEF DESCRIPTION OF THE DRAWINGS

The aspect defined above and further aspects, features and advantages of the present invention can also be derived from the examples of embodiments to be described herein after and are explained with reference to examples of embodiments, but to which the invention is not limited. The invention will be described in more detail hereinafter with reference to the drawings.

FIG. 1 shows an ultrasound medical imaging system;

FIG. 2 shows a schematic diagram of the method steps according to an exemplary embodiment of the invention;

FIG. 3 shows a first and a second ultrasound image plane of an object;

FIG. 4 schematically shows the arrangement of two different image planes;

FIG. 5 shows quantification data in form of a time intensity curve for two different image planes;

FIG. 6 shows a composite quantification measurement according to the invention; and

FIG. 7 schematically shows method steps to another exemplary embodiment of the invention.

### DETAILED DESCRIPTION OF EMBODIMENTS

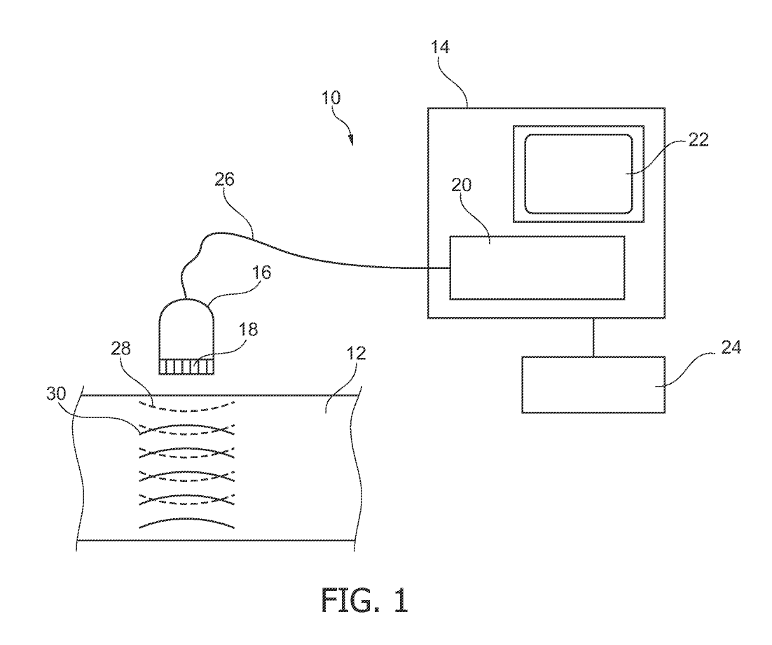

FIG. 1 schematically shows an ultrasound medical imaging system 10 for providing information about a region of interest of an object 12, wherein the system 10 comprises an ultrasound image data acquisition device 14, comprising an ultrasound probe 16 with an ultrasound transducer 18, a data processing unit 20, a display device 22 and an interface unit 24. For example, the ultrasound probe 16 is connected to the data processing unit 20 by a cable connection 26. The transducer 18 transmits ultrasound energy into an image region of the object 12, for example a patient's body. The transducer 18 then receives reflected ultrasound energy from organs or other features within the patient's body (not further shown). The ultrasound energy transmitting and receiving is indicated by curved lines 28, 30.

The image data acquisition device 14 is adapted to acquire at least a first and a second ultrasound image plane of the object 12. The interface unit 24 is provided such that a region of interest in the acquired first and second image planes of the object 12 can be determined, for example by the user.

In another exemplary embodiment, not shown, the region of interest is proposed by the ultrasound image data acquisition device 14, which for example can be displayed on the display 22, and the user can then confirm the proposal by inputting a command, for example by the interface 24.

The data processing unit 20 is adapted to determine first quantification data for the region of interest from the first image plane and to determine second quantification data for the region of interest from the second image plane. The data processing unit 20 is further adapted to generate a composite quantification measurement by combining the determined quantification data of the first image plane and the determined quantification data of the second image plane. The composite quantification measurement can then be provided to the user, for example by the display device 22.

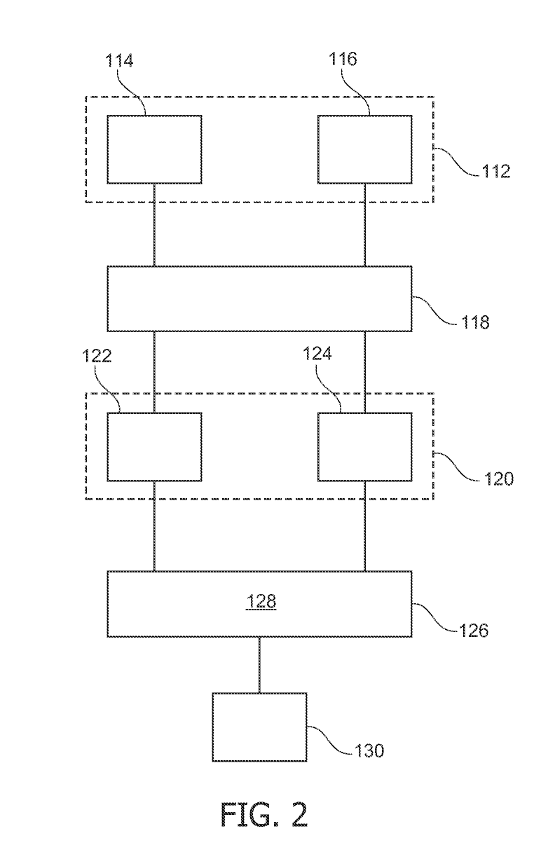

In the following, the basic method steps according to an exemplary embodiment of the invention will be described with reference to FIG. 2. In an acquisition step 112 (indicated by a dotted line), a first ultra sound image plane 114 and a second ultrasound image plane 116 of an object are acquired. In a determining step 118, a region of interest in the at least first and second image planes 114, 116 of the object are determined. Then, in a further determination step 120, also indicated by a dotted frame line, first quantification data 122 for the region of interest from the first image plane 114 is determined and second quantification data 124 for the region of interest from the second image plane 116 is determined.

Then, in a generating step 126, a composite quantification measurement 128 is generated by combining the determined first quantification data 122 of the first image plane 114 and the second determined quantification data 124 of the second image plane 116. Finally, in a providing step 130, the composite quantification measurement 128 is provided to the user. According to an exemplary embodiment, the region of interest is determined on behalf of the user's input in the determining step 118. For example, the providing step 130 comprises displaying the composite quantification measurement 128 to the user, for example on the display device 22.

According to an exemplary embodiment, the first image plane 114 and the second image plane 116 are acquired in different geometrical planes. According to an exemplary embodiment, not further shown, the acquisition step 112 comprises acquiring at least one sequence of image planes, wherein the first and the second image planes 114, 116 belong to the sequence and wherein quantification data for the region of interest is determined for at least a part of the image planes of the sequence.

According to an exemplary embodiment, the acquisition step 112 comprises acquiring a first sequence of image planes from a first geometrical plane and a second sequence of image planes from a second geometrical plane. For example, the geometrical planes can be the elevation plane and the azimuthal plane perpendicular to the elevation plane (see FIG. 4). For example, the image planes of the first and the second sequences are time registered. The quantification data is determined for the image planes of the first sequence and for the image planes of the second sequence and the determined quantification data of registered image planes of the first and the second sequences are then combined to generate the composite quantification measurement.

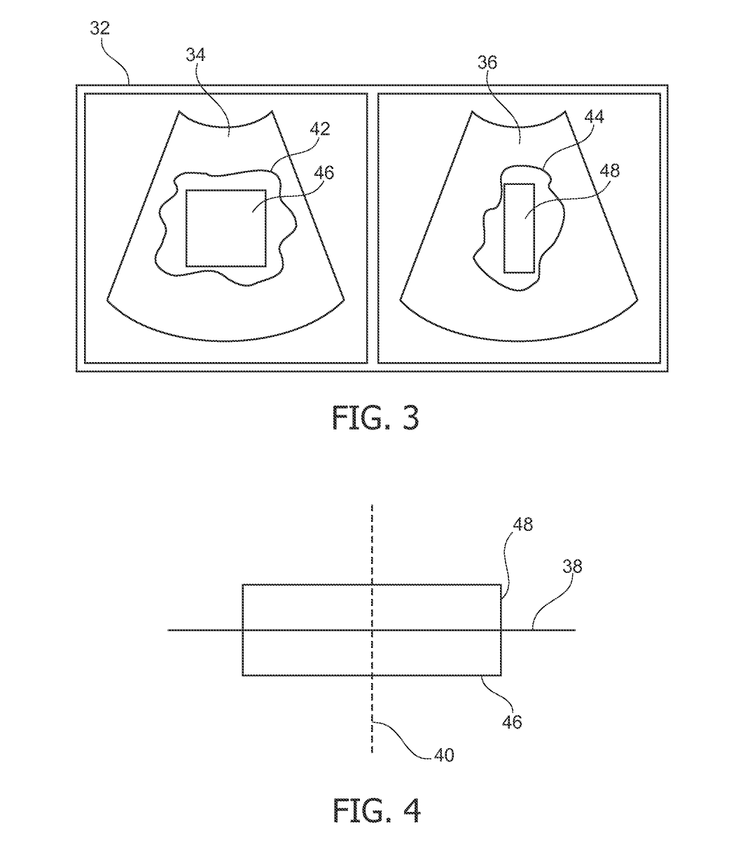

With reference to FIG. 3, an exemplary embodiment is described in the following. FIG. 3 shows a part of a display 32 that is shown by the display device 22. In the left hand part of the display area 32, a first ultrasound image plane 34 of an object is shown and a second ultrasound image plane 36 is shown in the right half of the display area 32.

For example, the displayed ultrasound image plane 34 results from the acquired first image plane 114 in FIG. 2 and the second ultrasound image plane 36 displayed results from the second acquired ultrasound image plane 116 in FIG. 2. The first ultrasound image plane 34 is acquired in an azimuthal plane 38 whereas the second ultrasound image plane 36 shown on the right side is acquired in an elevation plane 40.

As can be seen from FIG. 4, the azimuthal plane 38 is perpendicular to the elevation plane 40. The schematic arrangement of the two geometrical planes 38, 40 shown in FIG. 4 is so to speak seen from the top.

In the images indicated in FIG. 3 resulting from image planes, a region of interest of the object is indicated by a free surrounding line 42 in the first image plane 34 and by a second surrounding line 44 in a second image plane 36. The region of interest indicated by the lines 42, 44 relates to, for example, a tumour 46, indicated by a simplified rectangle. The two geometrical planes 38, 40 in which the acquired image planes 34, 36 have been acquired are perpendicular to each other, the rectangles 46 representing the tumour have different shapes according to different directions of view.

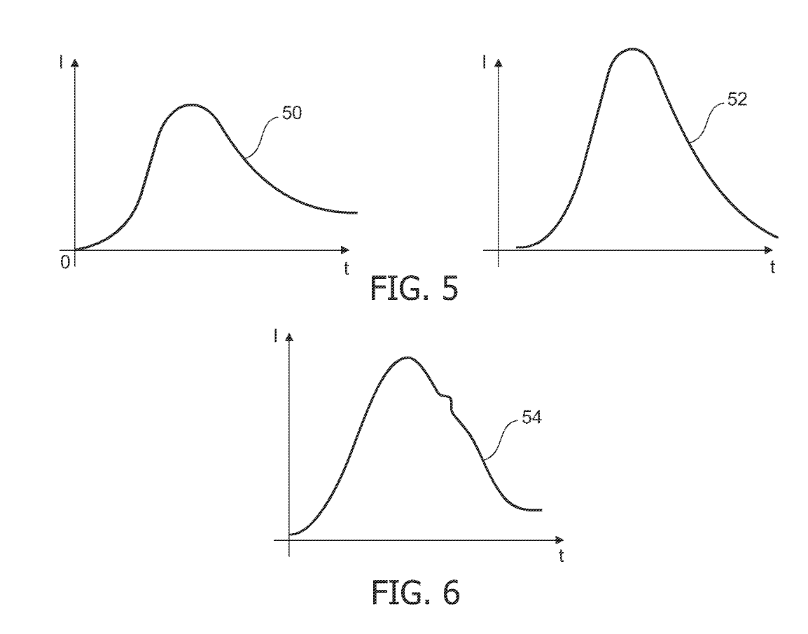

After acquiring the image planes and determining the region of interest, quantification data is determined for the region of interest, which is indicated in FIG. 5. As an example, FIG. 5 shows a first time intensity curve 50 for the region of interest 42 for the azimuthal plane 38 in the left part of FIG. 5. The intensity is listed on the Y-axis and the time is indicated on the X-axis of the coordinate system of the graph. In the right half of FIG. 5, a second time intensity curve 52 is shown for the region of interest of the elevation plane 40.

According to the invention, in order to provide the user with enhanced information, the determined quantification data of the first image plane and the determined quantification data of the second image plane are combined, generating a composite quantification measurement 54 which is shown in FIG. 6. Here, the Y-axis of the coordinate system relates to the intensity and the X-axis relates to the time.

As an example for the generating process, the combination of the determined quantification data of the first and the second image plane comprises an averaging as a mathematical function.

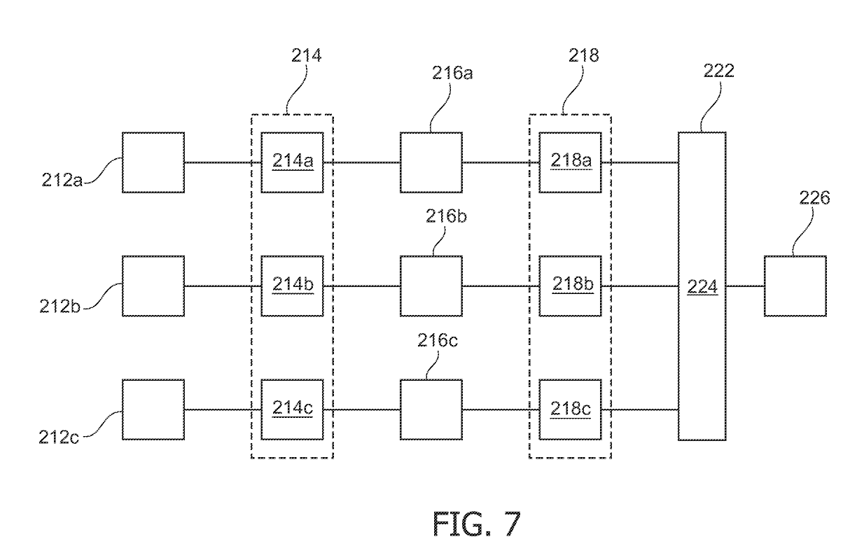

A further exemplary embodiment of the method according to the invention is schematically shown in FIG. 7. Several sequences 212a, 212b, 212c are acquired over a period of time. The sequences each comprise at least two image planes. The period of time can relate to a medical treatment procedure, for example. A period of time can also relate to a complex or longer operation or to the patient's stay in the hospital, for example. Then, a region of interest is determined for the image planes of the sequences in a determining step 214 indicated by a dotted line surrounding the individual steps. The determination of the region of interest can take place directly after acquiring the image planes in the acquisition step 212a, 212b and 212c.

According to an exemplary embodiment, the determination of the region of interest takes place once all sequences 212a, 212b, 212c have been acquired.

Next, at least first and second quantification data 216a, 216b, 216c are determined for the region of interest from the sequences 212a, 212b and 212c. The sequences comprise at least two image plane s acquired from different geometrical planes. The determination step 216 comprises determining quantification data for at least the region of interest from the first image plane and from the second image plane of the particular sequence 212. In a generating step 218, indicated by a dotted line, composite quantification measurements 218a, 218b, 218c are generated by combining the quantification data of the several sequences. Further, the qualification measurements 218a, 218b and 218c are compared in a comparison step 222 to detect differences and relations 224 of composite quantification measurements. The detected differences and relations are provided to the user in, for example, a display step 226.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage.

A computer program may be stored and/or distributed on a suitable medium, such as an optical storage medium or a solid state medium supplied together with or as part of other hardware, but may also be distributed in other forms, such as via the internet or other wired or wireless telecommunication systems.

Any reference signs in the claims should not be construed as limiting the scope.

1. Ultrasound medical imaging system for providing information about a region of interest of an object, the system comprising:
an ultrasound image data acquisition device comprising an ultrasound probe with an ultrasound transducer;
a data processing unit;
a display device; and
an interface unit;
wherein the image data acquisition device is adapted to acquire at least a first and a second ultrasound image plane of an object;
wherein the interface unit is adapted to determine a region of interest in the at least first and second image planes of the object;
wherein the data processing unit is adapted to determine first quantification data for the region of interest from the first image plane; to determine second quantification data for the region of interest from the second image plane; and to generate a composite quantification measurement by combining the determined first quantification data of the first image plane and the determined second quantification data of the second image plane;
wherein the display device is adapted to provide the composite quantification measurement to the user;
wherein the image data acquisition device is adapted to acquire several sequences over a period of time wherein the sequences each comprise at least two image planes;
wherein the interface unit is adapted to determine a region of interest in the image planes of the sequences;
wherein the data processing unit is adapted to determine at least first and second quantification data for the region of interest from the image planes;
wherein the data processing unit is adapted to generate a composite quantification measurement for each of the sequences by combining determined quantification data of at least a part of the image planes of each sequence; to compare the composite quantification measurements to detect differences and relations; and
wherein the display device is adapted to provide the differences and relations to the user.

2. Imaging system according to claim 1, wherein the image data acquisition device is adapted to acquire the first image plane and the second image plane in different geometrical planes.

3. Imaging system according to claim 1, wherein the image data acquisition device is adapted to acquire a first sequence of image planes from a first geometrical plane and a second sequence of image planes from a second geometrical plane.

4. (canceled)

5. Method for providing information about a region of interest of an object, the method comprising:
acquiring at least a first and a second ultrasound image plane of an object;
determining a region of interest in the at least first and second image planes of the object;
determining first quantification data for the region of interest from the first image plane; and determining second quantification data for the region of interest from the second image plane;
generating a composite quantification measurement by combining the determined first quantification data of the first image plane and the determined second quantification data of the second image plane;
providing the composite quantification measurement to the user;
wherein several sequences are acquired over a period of time; wherein the sequences each comprise at least two image planes;
wherein a region of interest is determined in the image planes of the sequences;
wherein at least first and second quantification data is determined for the region of interest in the image planes;
wherein a composite quantification measurement is generated for each of the sequences by combining the determined quantification data of at least a part of the image planes of each sequence;
wherein the composite quantification measurements are compared to detect differences and relations; and
wherein the differences and relations are provided to the user.

6. Method according to claim 5, wherein the first image plane and the second image plane are acquired in different geometrical planes.

7. Method according to claim 5, wherein at least one sequence of image planes is acquired; wherein the first and the second image planes belong to the sequence; and wherein quantification data for the region of interest is determined for at least a part of the image planes of the sequence.

8. Method according to claim 7, wherein a first sequence of image planes is acquired from a first geometrical plane and a second sequence of image planes is acquired from a second geometrical plane.

9. Method according to claim 5, wherein the quantification measurements comprise functions over time.

10.-12. (canceled)
